(19) United States
(12) Patent Application Publication
(10) Pub. No.: US 2013/0264136 A1
(43) Pub. Date: Oct. 10, 2013

(54) WHEEL-STEERED VEHICLE

(71) Applicants: Lena Larsson, Vastra Frolunda (SE); Jan Öberg, Goteborg (SE)

(72) Inventors: Lena Larsson, Vastra Frolunda (SE); Jan Öberg, Goteborg (SE)

(73) Assignee: Volvo Lastvagnar AB, Goteborg (SE)

(21) Appl. No.: 13/993,349

(22) PCT Filed: Dec. 17, 2010
(86) PCT No.: PCT/SE10/00303

§ 371 Date: Jun. 12, 2013

(51) Int. Cl. B60K 6/00

(52) U.S. Cl. CPC B60K 6/00
USPC 180/252

(57) ABSTRACT

A wheel-steered vehicle includes a frame and steerable wheels on at least one front axle, wherein the frame includes a front frame section including the at least one front axle and a rear frame section including at least one rear axle, the front and rear frame sections being arranged along a longitudinal direction and being connected by at least a first pivot joint wherein the at least first pivot joint has a first pivot axis oriented in the longitudinal direction, and wherein the wheels on the at least one front axle include a separate drive unit for each steerable wheel on the at least one front axle.

### BACKGROUND AND SUMMARY

The invention relates, according to an aspect thereof, to a wheel-steered vehicle comprising a frame and steerable wheels.

Commercial vehicles such as trucks are designed for driving on normal tarmac roads (“on-road”). They cannot be used on rough roads (“off-road”) of construction sites without the risk of severe damage to chassis and other components.

On the other hand, frame-steered vehicles, also known as articulated haulers are well known in the art of heavy off-road construction vehicles. An articulation joint is arranged between a front frame section and a rear frame section of the vehicle so that frame-steered vehicles are very agile and robust. The vehicle is steered by turning the from frame section about the articulation joint. Frame-steered vehicles are normally not designed for driving on normal tarmac roads but on rough ground in construction sites carrying heavy load with a high load per axle which is higher than legal limits for axle load on public tarmac roads. Due to robustness and load carrying requirements in construction areas, such vehicles are already heavy in an empty state and are in a fully loaded state too heavy for normal roads. When material loaded on a construction vehicle has to be transported on the road, the material has to be moved from the construction vehicle to a truck which can drive on tarmac roads.

U.S. Pat. No. 3,669,469 discloses an all-purpose vehicle with front and rear sections having a cab on the front section while the rear section carries load. The sections are coupled by a rotating hitch. The vehicle can be biaxial or be provided with a tandem axle and be provided with all-wheel drive.

It is desirable to provide a vehicle which has at least a part of the agility of a frame-steered vehicle used on construction sites but can drive longer distances on normal roads as well.

A wheel-steered vehicle is proposed comprising a frame and steerable wheels on at least one front axle, wherein the frame comprises a front frame section including the at least one front axle and a rear frame section including at least one rear axle, the front and rear frame sections being arranged along a longitudinal direction and being connected by at least a first pivot joint, wherein the at least first pivot joint has a first pivot axis oriented in the longitudinal direction, and wherein the steerable wheels on the at least one from axle comprise a separate drive unit for each steerable wheel on the at least one front axle.

The vehicle is steered by turning the wheels with respect to the frame according to an Ackermann-type steering geometry. Each of the steerable wheels may be steered individually. Advantageously, a short and compact vehicle can be provided with a high agility and the possibility to reduce axle and wheel load compared to an articulated hauler. Because the steerable wheels can be individually driven wheels where each wheel has its own drive unit, there is no voluminous propeller shaft extending from a central drive unit such as a combustion engine to the wheels on the front axle for driving the front wheels. Particularly, additional to the steering angle of the wheels, a front wheel speed or torque may be established individually at least between the front wheels at the same front axle, and/or also compared to wheels arranged on axles in the rear frame section. Because there is no propeller shaft and drop box or transfer box is not necessary in the front frame section, saving space and weight. The vehicle can drive substantial distances on-road with a reasonable speed as well as manoeuvre off-road like an off-road vehicle, for instance an off-road vehicle.

Particularly, the front frame section is used with the rear frame section in combination only. The front frame section may comprise only one front axle or one front axle aggregate. The front frame section may also comprise two front axles, e.g. when the vehicle is a crane.

Advantageously, the front axle may have individually steerable wheel speed. The steering can be performed by action of the individual drive units of the driven wheels on the front axle.

Particularly, the first pivot joint may have a locked state, thus improving the driveability and stability of the vehicle when driving on even surfaces.

Advantageously, the vehicle may have an ordinary truck-type suspension, where the wheels on one side of the vehicle can move at least vertically independent from wheels on the other side of the vehicle. If two or more of the wheels are attached to a physical axle component, the axle component can move vertically relative to the frame. The truck-type suspension may be provided at least at the at least one rear axle. The front axle suspension can also be a truck-type suspension. The driving properties of the vehicle on even roads are similar to those of a truck. Having a truck-type suspension allows the vehicle to in with improved comfort and higher speed on normal roads. As a result, a vehicle, particularly a construction vehicle, can be provided which is capable of safely and comfortably moving off-road as well of on-road while carrying a reasonable weight of payload.

Expediently, the rear frame section may have at least two axles. The advantage of at least two rear axles is a higher load carrying capacity of the vehicle and a reduced risk of damage to the ground by the wheels, thereby maintaining a higher friction and load carrying capacity of the ground.

According to a further embodiment of an aspect of the invention, a bearing of the first joint may be arranged around a gearbox. The bearing may alternatively be arranged around another appropriate component, thus providing a compact and space-saving arrangement of the first joint. The gearbox (or the component) may be arranged in the front or the rear frame section of the vehicle.

According to a further embodiment of an aspect of the invention, an electric motor and/or a hydraulic motor may be provided for driving the driven wheels. Particularly, the drive units driving the wheels can be integrated in the wheels as wheel motors. Advantageously, such individual drive units can be mounted in a compact way and act directly on the steerable wheels. Because there is no propeller shaft and drop box it is possible to mount the first pivot joint, a rotating hitch, close to the front axle. Instead of a large bulky propeller shaft, a hydraulic pump or a generator or the like for supplying energy to the wheel drive units can be mounted.

According to a further embodiment of an aspect of the invention, the front and/or the rear frame section may be composed of truck-beam components. It is of advantage that components used for normal trucks can be used. The beams can have a C-shape cross section. Of course, other cross sections are possible, such as a T-shape, a double-T-shape, Z-shape, a square, as is used for truck frames.

According to a further embodiment of an aspect of the invention, the at least one rear axle may be driven by a propeller shaft coupled to a central drive unit, such as an internal combustion engine, providing drive power for the at least one rear axle of the vehicle. Expediently, the central drive unit is arranged at the front frame section.

According to a further embodiment of an aspect of the invention, the rear frame section may comprise a bogie axle aggregate. Advantageously, components used for normal trucks can be used, thus reducing manufacturing costs of the vehicle.

According to a further embodiment of an aspect of the invention, at least the rear frame section may comprise at least one of a leaf spring suspension, an air spring suspension, a gas suspension, a hydraulic suspension, or any combination thereof. Advantageously, components used for normal trucks can be used, thus reducing manufacturing costs of the vehicle.

According to a further favourable embodiment of an aspect of the invention, a central drive unit such as a combustion engine may be arranged substantially above the at least one front axle. Thus, the driver position in a cab may also be arranged substantially above the at least one front axle. The cab is arranged at the front frame section. The arrangement is equivalent to the arrangement of cab, axle and drive unit of a conventional truck. It is of advantage that components used for normal trucks can be used. Particularly, a normal driver cab of a truck can be used, thus reducing manufacturing costs of the vehicle, as same parts for trucks and construction vehicles can be used. A longitudinal extension between a centre of the front axle and a centre of the first pivot joint is comparable to a wheel hub distance of the at least one front axle. Particularly, a distance between the front wheel axle and the first pivot joint is as small as possible, preferably comparable to, more preferably not exceed the wheel hub distance of the front wheel axle. The shorter the distance, the more stable is the vehicle.

According to a further favourable embodiment of an aspect of the invention, a second joint may be provided having a pivot axis oriented transverse to the longitudinal direction, particularly perpendicular to the ground. Twisting of the front frame section and/or the rear frame section about the longitudinal axis of the vehicle improves the agility and maneuverability of the vehicle on rough surfaces.

According to a further favourable embodiment of an aspect of the invention, a steerable axle may be arranged at the rear frame section. The load capacity, drivability and stability of the vehicle can be improved.

### BRIEF DESCRIPTION OF THE DRAWINGS

The present invention may best be understood from the following detailed description of the embodiments, but not restricted to the embodiments, wherein is shown schematically:

FIG. 1 in a side view an example embodiment of a wheel-steered vehicle according to an aspect of the invention having a rotation hinge;

FIG. 2 in a plait view the vehicle of FIG. 1 illustrating an Ackermann-type steering geometry;

FIG. 3 in a side view another example embodiment of a wheel-steered vehicle according to an aspect of the invention having a rotation hinge and an articulation joint;

FIG. 4 in a plan view the vehicle of FIG. 3; and

FIG. 5 in a plan view another example embodiment of a wheel-steered vehicle according to an aspect of the invention having two steerable axles.

### DETAILED DESCRIPTION

In the drawings, equal or similar elements are referred to by equal reference numerals. The drawings are merely schematic representations, not intended to portray specific parameters of the invention. Moreover, the drawings are intended to depict only typical embodiments of the invention and therefore should not be considered as limiting the scope of the invention.

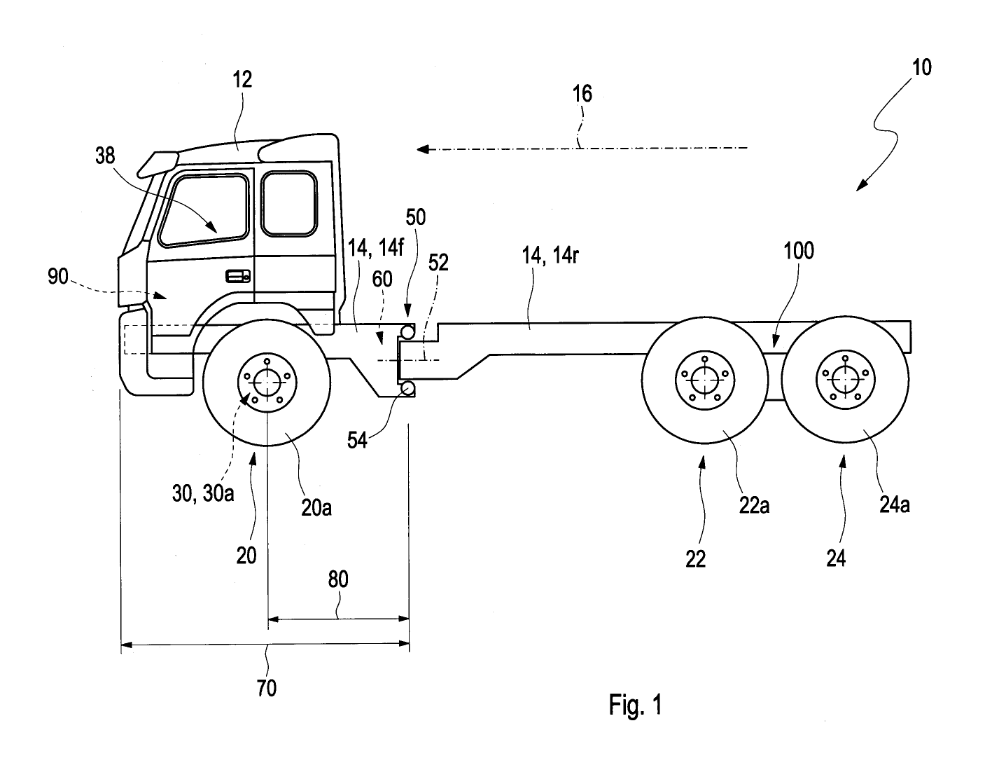

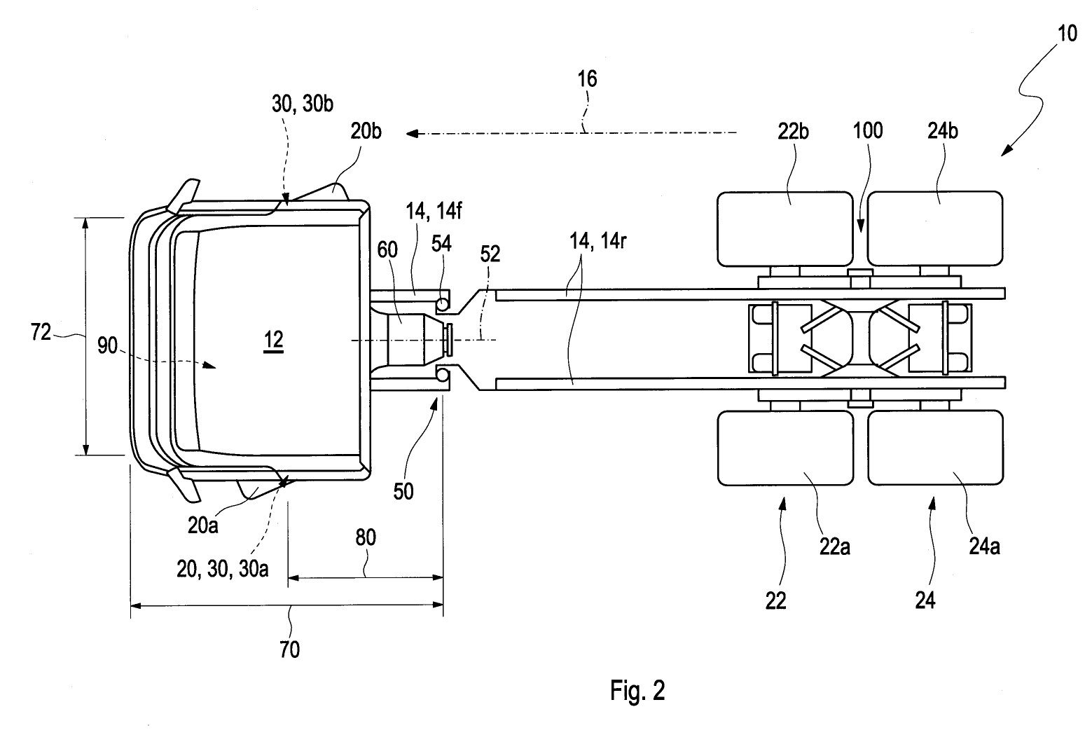

A wheel steered vehicle 10 is depicted in FIG. 1 in a side view and in a plan view in FIG. 2. The vehicle 10 comprises a frame 14 including a front frame section 14f and a rear frame section 14r which are coupled to each other by a first joint 50. The front frame section 14f includes a front axle 20 and the rear frame section 14r includes a bogie axle aggregate 100 with two rear axles 22, 24 and wheels 22a, 22b and 24a, 24b. The front frame section 14f has an advantageously short length 70.

The front and rear frame sections 14f, 14r of the frame 14 are arranged along a longitudinal axis 16 and are connected by the first pivot joint 50 having a first pivot axis 52 in the longitudinal direction 16, i.e. parallel to the ground. The first pivot joint 50 constitutes an oscillation joint which allows for tilting the front frame section for steering the vehicle 10, thus allowing a twist of the vehicle 10 about the longitudinal direction 16 as desired when the vehicle 10 is moving on rough surfaces.

The bearing 54 of the first pivot joint 50 is arranged around a gearbox 60. Alternatively, the first pivot joint 50 can be supported by other components in case the gearbox 60 would be mounted at the rear frame section 14r.

The front axle 20 comprises a pair of steerable wheels 20a, 20b so that the vehicle 10 can be steered according to an Ackermann-type steering, geometry indicated in FIG. 2. The steerable wheels 20a, 20b of the front axle 20 are individually driven so that each steerable wheel 20a, 20b has its own drive unit 30, which is indicated by an arrow. Such individual drive units 30 are associated with the wheels 20a, 20b so that the front wheel speed or torque can be established individually at least to each other and/or also compared to rear wheels 22a, 22b, 24a, 24b of the rear axles 22, 24. The drive unit 30 can be, for instance, an electric motor, a hydraulic motor and the like. Because of the individual wheel drive, the steerable and driven wheels 20a, 20b arranged in the front frame section 14f are not connected to a central propeller shaft coupled to a central drive unit 90 such as a combustion engine.

The first pivot joint 50 is arranged at a distance 80 from the centre of the front axle 20. The distance 80 can be advantageously short.

For a stable drive, particularly on even ground such as tarmac roads, the first pivot joint 50 has a locked state.

A cab 12 as known from conventional trucks can be used as driver cab on the front frame section 14f. As known from truck cabs a driver's position 38, particularly the driver's seat, is arranged substantially above the front axle 20 and a central drive unit 90, for instance a combustion engine (indicated by a broken line) which is provides propulsion power for the rear axle arrogated 100. The vehicle 10 can advantageously utilize more conventional truck components than the cab 12. For instance, the front and/or the rear frame section 14f, 14r can be composed of C-shaped beams well known from trucks. Of course, other cross sections are possible. By way of example, the bogie axle aggregate 100 mounted at the rear frame section 14r is also a conventional truck component. Further, the rear frame section 14r may comprise a typical truck suspension, such as a leaf spring suspension, an air spring suspension, a gas suspension, a hydraulic suspension or any combination thereof.

At least one of the rear axles 22, 24, or both, is driven by a propeller shaft (not shown) coupled to the central drive unit 90 arranged at the front frame section 14f.

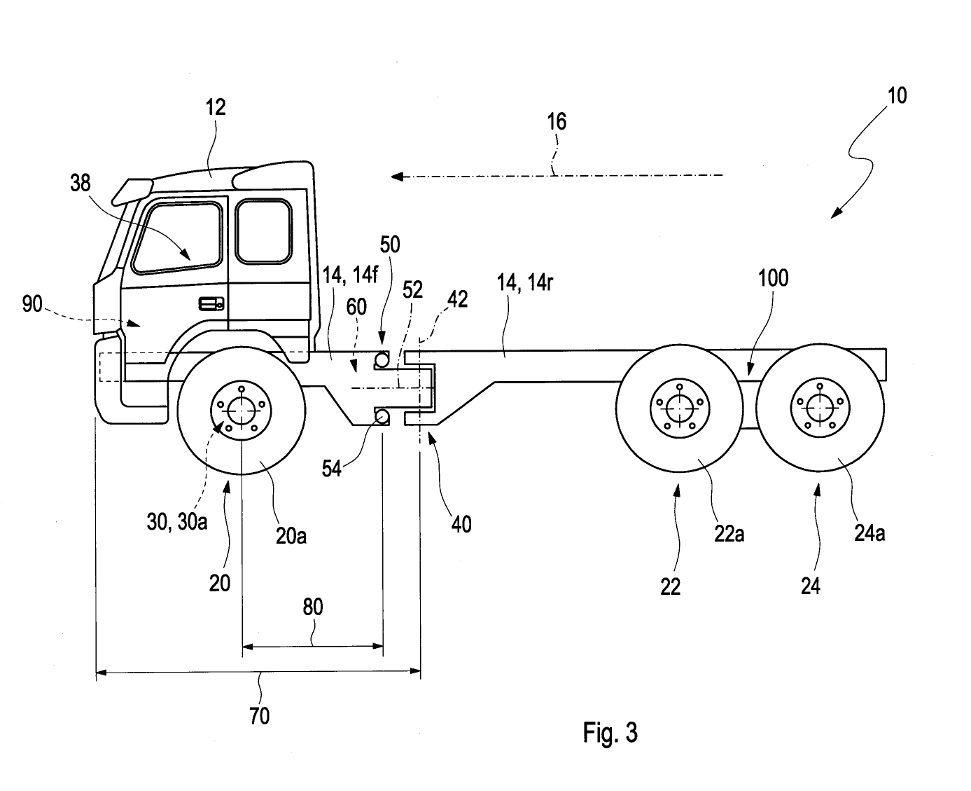

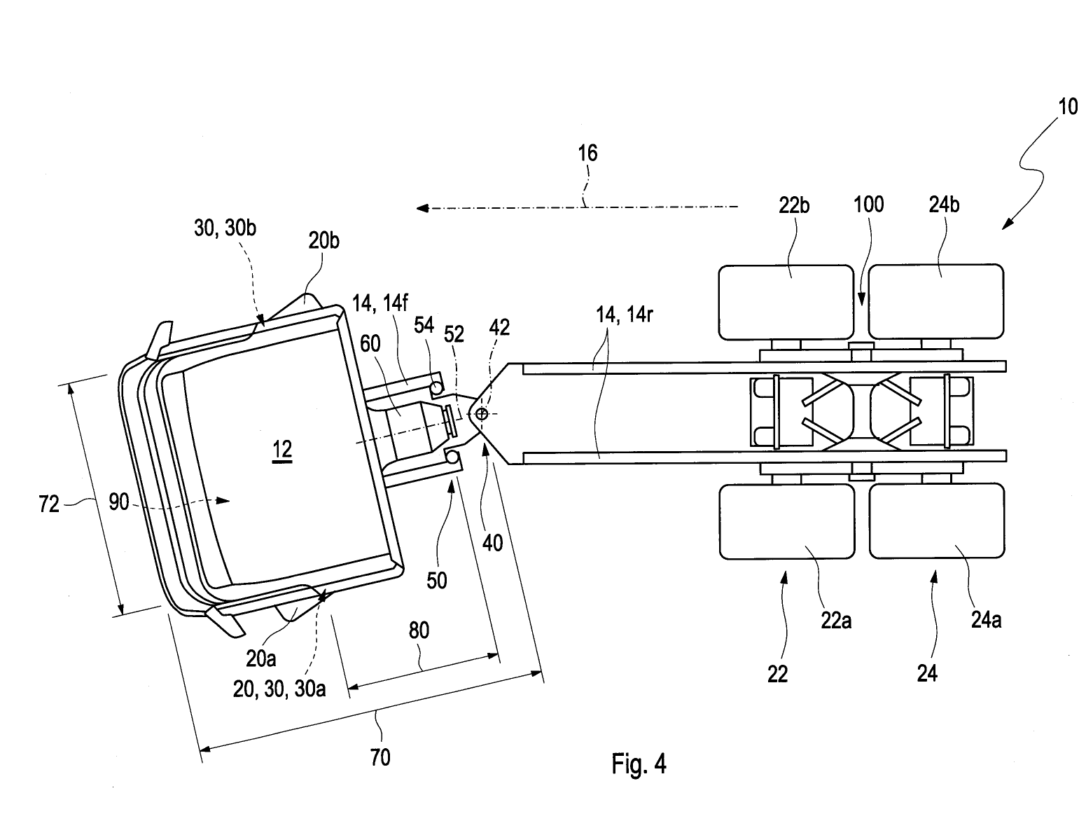

FIGS. 3 and 4 illustrate another example embodiment of a wheel-steered vehicle 10 according to an aspect of the invention having an articulation joint (also know as oscillation joint) as first pivot joint 50 and rotation hinge as second pivot joint 40, in a side view FIG. 3) and in a plan view the vehicle (FIG. 4).

The vehicle 10 has a front axle 20 in the front frame section 14f with steerable wheels 20a, 20b, where the steerable wheel 20a is driven by an individual drive unit 30a and the wheel 20b is driven by an individual drive unit 30b. The rear frame section 14r has a bogie axle aggregate 100 with rear axles 22 (with wheels 22a, 22b) and 24 (with wheels 24a, 24b).

As shown in the previous Figures, the first joint 50 has a pivot axis 52 along the longitudinal direction 16 and is supported by a bearing 54 arranged by way of example around a gearbox 60. The second joint 40 has a pivot axis 42 transversal to the longitudinal direction 16, thus allowing a rotation of the vehicle 10 about the pivot axis 42 as desired when the vehicle 10 is moving on rough surfaces. The second pivot joint 40 constitutes a rotation hinge of the vehicle 10. Expediently, the front, and rear frame section 14f, 14r can perform cornering movements compared to each other, so that the vehicle 10 can turn about a centre with a comparably small turning radius. The front section of the vehicle 10, the bogie axle aggregate 100 and the steerable wheels 20a, 20b with their cross sections can all be tangential to the common turning radius enter point.

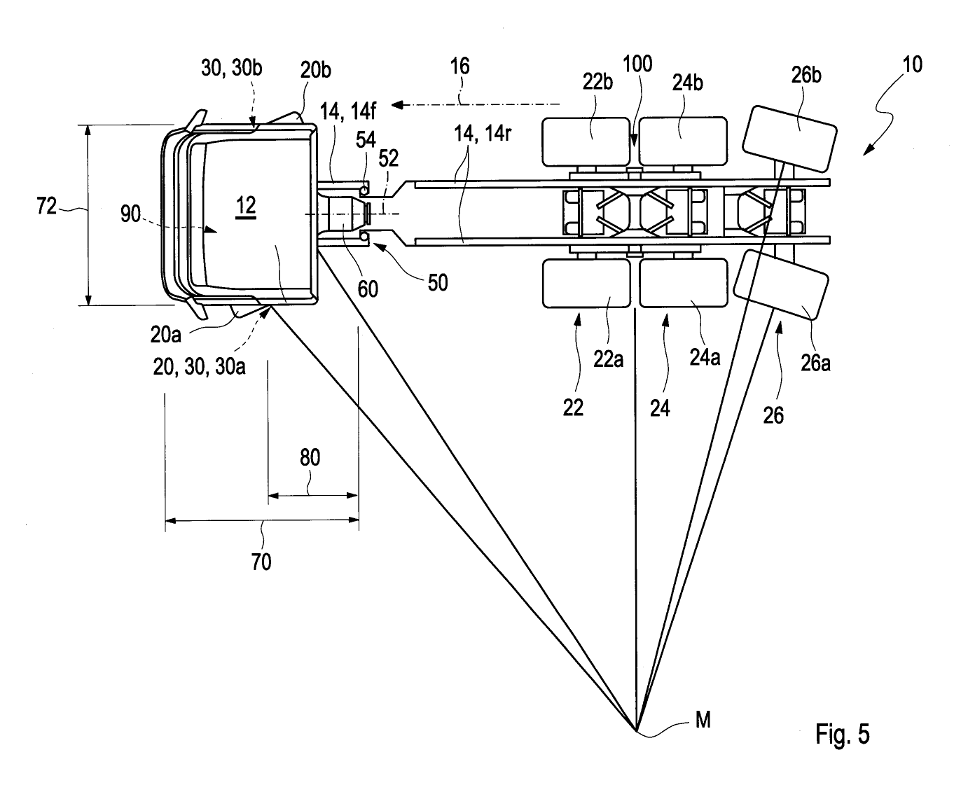

FIG. 5 shows in a schematic plan view a vehicle 10 similar to the vehicle 10 shown in the preceding Figures, indicating the Ackermann-type steering geometry of the vehicle 10, and having two steerable axles 20, 26, one at the front frame section 14r and one at the rear frame section 14r. For the general description of features common in the embodiments of vehicle 10 it is referred to the description of FIGS. 1 to 4 to avoid unnecessary repetitions.

The vehicle 10 has a front axle 20 in the front frame section 14f with steerable wheels 20a, 20b, where the steerable wheel 20a is driven by drive unit 30a and the steerable wheel 20b is driven by drive unit 30b. The rear frame section 14r has three rear axles 22 (with wheels 22a, 22b), 24 (with wheels 24a, 24b), and 26 (with wheels 26a, 26b), where the rearmost axle 26 is steerable.

When cornering, the steerable wheels 20a, 20b at the front frame section 14f are turned by a first steering angle. The wheels 26a, 26b of the rearmost axle 26 can be turned by a corresponding steering angle for wheel 26b and a corresponding steering angle for wheel 26a.

The vehicle 10 can turn about a centre M with a comparably small turning radius. The front frame section 14f, the bogie aggregate 100 and the cross section of the steerable wheels 20a, 20b, 26a, 25b can all be tangential to the common turning radius enter point M.

The vehicle 10 according to an aspect of the invention and discussed in the example embodiments in FIGS. 1 to 5 is designed for off-road and on-road driving. For on-road driving the vehicle 10 can be used like a conventional truck, for off-road driving the vehicle 10 can be used like a conventional off-road articulated vehicle like a dumper. The wheel steered vehicle 10 combines the features of an on-road truck and an articulated hauler. Compared to an ordinary off-road articulated vehicle the vehicle 10 provides high driving speed. Transportation of payload can be done both off-road and on-road with the same vehicle 10 without the necessity of reloading between different vehicles for on-road transport of the payload.

1. A wheel-steered vehicle (10) comprising a frame (14) and steerable wheels (20a, 20b) on at least one front axle (20), wherein the frame (14) comprises a front frame section (140 including the at least one front axle (20) and a rear frame section (14r) including at least one rear axle (22, 24), the front and rear frame sections (14f, 14r) being arranged along a longitudinal direction (16) and being connected by at least a first pivot joint (50) wherein the at least first pivot joint (50) has a first pivot axis (52) oriented in the longitudinal direction (16), and wherein the wheels (20a, 20b) on the at least one front axle (20) comprise a separate drive unit (30, 30a, 30b) for each steerable wheel (20a, 20b) on the at least one front axle (20).

2. The wheel-steered vehicle according to claim 1, wherein the drive unit (30) is an electric motor or a hydraulic motor.

3. The wheel-steered vehicle according to claim 1 or 2, wherein the first pivot joint (50) has a locked state.

4. The wheel-steered vehicle according to any one of the preceding claims, wherein at least the at least one rear axle (22, 24, 26) is suspended by a truck-type suspension.

5. The wheel-steered vehicle according to any one of the preceding claims, wherein a bearing (54) of the first joint (50) is arranged around a gearbox (60).

6. The wheel-steered vehicle according to any one of the preceding claims, wherein the front and/or the rear frame section (14f, 14r) comprise truck-beam components.

7. The wheel-steered vehicle according to any one of the preceding claims, wherein the at least one rear axle (22, 24, 26) is driven by a propeller shaft coupled to a central drive unit (90).

8. The wheel-steered vehicle according to any one of the preceding claims, wherein the rear frame section (14r) comprises a bogie axle (100).

9. The wheel-steered vehicle according to any one of the preceding claims, wherein the rear frame section (14r) comprises at least one of a leaf spring suspension, an air spring suspension, a gas suspension, a hydraulic suspension, or any combination thereof.

10. The wheel-steered vehicle according to any one of the preceding claims, wherein a central drive unit (90) is arranged substantially above the at least one front axle (20).

11. The wheel-steered vehicle according to any one of the preceding claims, wherein a second joint (40) is provided having a pivot axis (42) oriented transverse to the longitudinal direction (16).

12. The wheel-steered vehicle according to any one of the preceding claims, wherein a steerable axle is arranged at the rear frame section (14r).

13. A wheel-steered vehicle comprising a frame and steerable wheels on at least one front axle, wherein the frame comprises a front frame section including the at least one front axle and a rear frame section including at least one rear axle, the front and rear frame sections being arranged along a longitudinal direction and being connected by at least a first pivot joint wherein the at least first pivot joint has a first pivot axis oriented in the longitudinal direction, and wherein the wheels on the at least one front axle comprise a separate drive unit for each steerable wheel on the at least one front axle.

14. The wheel-steered vehicle according to claim 13, wherein the drive unit is an electric motor or a hydraulic motor.

15. The wheel-steered vehicle according to claim 13, wherein the first pivot joint has a locked state.

16. The wheel-steered vehicle according to claim 13, wherein at least the at least one rear axle is suspended by a truck-type suspension.

17. The wheel-steered vehicle according to claim 13, wherein a bearing of the first joint is arranged around a gearbox.

18. The wheel-steered vehicle according to claim 13, wherein the front and/or the rear frame section comprise truck-beam components.

19. The wheel-steered vehicle according to claim 13, wherein the at least one rear axle is driven by a propeller shaft coupled to a central drive unit.

20. The wheel-steered vehicle according to claim 13, wherein the rear frame section comprises a bogie axle.

21. The wheel-steered vehicle according to claim 13, wherein the rear frame section comprises at least one of a leaf spring suspension, an air spring suspension, a gas suspension, a hydraulic suspension, or any combination thereof.

22. The wheel-steered vehicle according to claim 13, wherein a central drive unit is arranged substantially above the at least one front axle.

23. The wheel-steered vehicle according to claim 13, wherein a second joint is provided having a pivot axis oriented transverse to the longitudinal direction.

24. The wheel-steered vehicle according to claim 13, wherein a steerable axle is arranged at the rear frame section.
